(19) United States
(12) Patent Application Publication
(10) Pub. No.: US 2026/0036928 A1
(43) Pub. Date: Feb. 5, 2026

(54) FIXING DEVICE, IMAGE FORMING APPARATUS, AND CONTROL METHOD

(71) Applicant: KONICA MINOLTA, INC., Tokyo (JP)

(72) Inventor: Yutaka OTSUKA, Toyokawa-shi (JP)

(73) Assignee: KONICA MINOLTA, INC., Tokyo (JP)

(21) Appl. No.: 19/252,739

(22) Filed: Jun. 27, 2025

(30) Foreign Application Priority Data
Aug. 1, 2024 (JP) 2024126019

(51) Int. Cl. G03G 15/20

(52) U.S. Cl. CPC G03G 15/205; G03G 15/2017; G03G 15/2046; G03G 15/2064

(57) ABSTRACT

A fixing device includes a heating member provided with a heat source, a temperature detection sensor that changes a resistance value according to a temperature of the heating member, and a controller that calculates the resistance value of the temperature detection sensor based on an output voltage of the temperature detection sensor to detect the temperature of the heating member, and controls heating of the heat source. The controller calculates a correction coefficient for correcting the resistance value of the temperature detection sensor on the basis of an output voltage of the temperature detection sensor when a predetermined compensation condition is satisfied, and corrects the resistance value of the temperature detection sensor using the correction coefficient when the temperature of the heating member is detected.

### CROSS REFERENCE TO RELATED APPLICATIONS

This application is based on Japanese Patent Application No. 2024-126019 filed on Aug. 1, 2024. the contents of which are incorporated herein by reference.

### BACKGROUND OF THE INVENTION

### Technical Field

The present invention relates to a fixing device, an image forming apparatus, and a control method.

### Description of Related Art

An image forming apparatus that forms an image by an electrophotographic method includes a fixing device for fixing an image transferred onto a sheet such as a printing sheet. The fixing device forms a nip portion by bringing a heating member and a pressure member into contact with each other, performs heating processing and pressure processing on a sheet by sandwiching the sheet in the nip portion, and fixes an image on the sheet. The fixing device includes a temperature sensor that detects the temperature of the heating member, and performs temperature control based on the temperature detected by the temperature sensor. Conventionally, in this type of fixing device, it has been proposed to use a non-contact temperature sensor including a temperature detection element for detection and a temperature detection element for compensation (for example. Japanese Unexamined Patent Publication No. JP2023-183799A).

The temperature detection element changes an output voltage due to a change in resistance value in accordance with a temperature of an object to be measured. Therefore, the fixing device can detect the temperature of the heating member by an output voltage of the temperature detection element.

However, the resistance value of the temperature detection element changes over time. When the resistance value changes over time, the temperature of the heating member cannot be correctly detected. Therefore, for example, it is conceivable to compare the temperature detected by the output voltage of the temperature detection element with the temperature detected by another temperature sensor and calculate a correction coefficient for correcting the temperature detected by the temperature detection element.

However, in the method of calculating a correction coefficient for correcting the temperature and correcting the temperature detected by the temperature detection element based on the correction coefficient, there is a problem that a correct temperature cannot be detected in a temperature region other than the temperature region when the correction coefficient is calculated.

### SUMMARY OF THE INVENTION

The present invention has been devised in order to solve the above-described conventional problems. That is, an object of the present invention is to provide a fixing device, an image forming apparatus, and a control method that can detect a correct temperature by correcting a resistance value that has changed over time.

A first subject of the present invention is directed to a fixing device.

According to an aspect of the first subject, the fixing device includes: a heating member provided with a heat source; a temperature detection sensor that changes a resistance value according to a temperature of the heating member; and a controller that calculates the resistance value of the temperature detection sensor based on an output voltage of the temperature detection sensor to detect the temperature of the heating member, and controls heating of the heat source. The controller calculates a correction coefficient for correcting the resistance value of the temperature detection sensor on the basis of an output voltage of the temperature detection sensor when a predetermined compensation condition is satisfied, and corrects the resistance value of the temperature detection sensor using the correction coefficient when the temperature of the heating member is detected.

A second subject of the present invention is directed to an image forming apparatus.

According to an aspect of the second subject, the image forming apparatus includes an image forming unit that forms an image on a sheet, and a fixing device that fixes the image on the sheet. The fixing device includes a heating members provided with heat sources, a temperature detection sensor that changes a resistance value in accordance with a temperature of the heating member, and a controller that calculates the resistance value of the temperature detection sensor based on an output voltage of the temperature detection sensor to detect the temperature of the heating member, and controls heating of the heat source. The controller calculates a correction coefficient for correcting the resistance value of the temperature detection sensor on the basis of an output voltage of the temperature detection sensor when a predetermined compensation condition is satisfied, and corrects the resistance value of the temperature detection sensor using the correction coefficient when the temperature of the heating member is detected.

A third subject of the present invention is directed to a control method of a fixing device including a heating member provided with a heating source, and a temperature detection sensor that changes a resistance value in accordance with a temperature of the heating member.

According to an aspect of the third subject, the control method includes: calculating the resistance value

of the temperature detection sensor based on an output voltage of the temperature detection sensor to detect the temperature of the heating member; controlling heating of the heat source based on the detected temperature of the heating member; calculating a correction coefficient for correcting the resistance value of the temperature detection sensor on the basis of an output voltage of the temperature detection sensor when a predetermined compensation condition is satisfied; and correcting the resistance value of the temperature detection sensor using the correction coefficient when the temperature of the heating member is detected.

### BRIEF DESCRIPTION OF THE DRAWINGS

The advantages and features provided by one or more embodiments of the invention will become more fully understood from the detailed description given herein below and the appended drawings which are given by way of illustration only, and thus are not intended as a definition of the limits of the present invention.

FIG. 1 is a diagram illustrating an example of the configuration of an image forming apparatus:

FIG. 2 is a diagram illustrating a detailed configuration of the fixing device:

FIG. 3 is a perspective view illustrating a heating member and a pressure member of the fixing device:

FIG. 4 is a diagram illustrating an example of the configuration of a temperature detection sensor:

FIG. 5 is a block diagram illustrating a functional configuration of a controller:

FIG. 6 is a diagram illustrating an example of TR characteristic information;

FIG. 7 is a flowchart illustrating an example of a processing procedure by a CPU of a controller:

FIG. 8 is a flowchart illustrating an example of a detailed processing procedure of heating control: and

FIG. 9 is a flowchart illustrating an example of a detailed processing procedure of resistance compensation processing.

### DETAILED DESCRIPTION OF EMBODIMENTS

Hereinafter, one or more embodiments of the present invention will be described with reference to the drawings. However, the scope of the invention is not limited to the disclosed embodiments. Note that in the embodiments described below, common elements are denoted by the same reference signs, and redundant description thereof is omitted.

### Preferred Embodiment

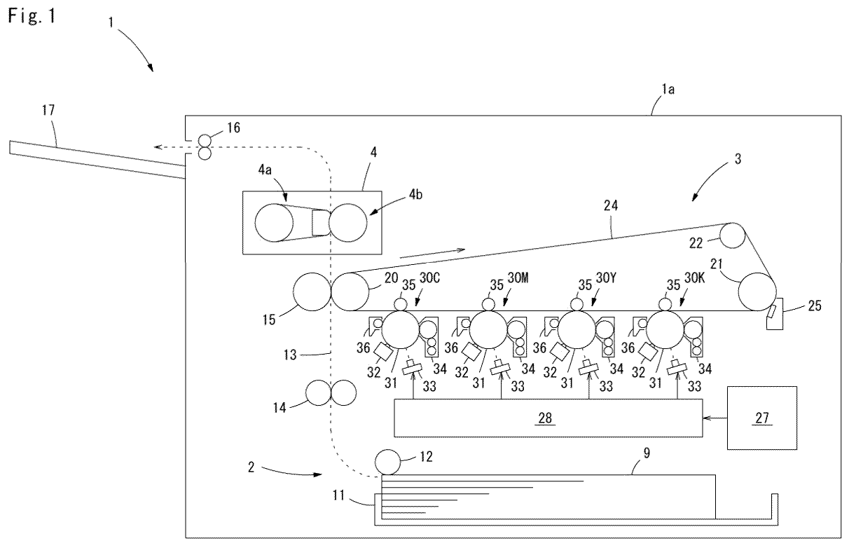

FIG. 1 illustrates an example of the configuration of an image forming apparatus 1 according to an embodiment of the present invention. The image forming apparatus 1 forms and outputs an image on a sheet 9 such as a printing sheet by an electrophotographic method. The image forming apparatus 1 includes a sheet feed and conveyance section 2, an image forming section 3 and a fixing device 4 inside of the apparatus main body 1a.

The sheet feed and conveyance section 2 convey the sheet 9 along a conveyance path 13 formed inside of the apparatus main body 1a. The sheet feed and conveyance section 2 include a sheet feed cassette 11, a sheet feed roller 12, a timing roller 14, a secondary transfer roller 15, and a sheet ejection roller 16. The sheet feed cassette 11 stores a bundle of sheets 9. The sheet feed roller 12 picks up only one uppermost sheet 9 of a bundle of the sheets 9 accommodated in the sheet feed cassette 11 and feeds the sheet 9 to the conveyance path 13. The timing roller 14 feeds the sheet 9 fed by the sheet feed roller 12 to the secondary transfer roller 15 in accordance with the operation of the image forming section 3. That is, the timing roller 14 temporarily stops conveyance of the sheet 9 fed to the conveyance path 13 by the sheet feed roller 12. The timing roller 14 is then driven in accordance with the timing at which the image formed by the image forming section 3 is conveyed to the position of the secondary transfer roller 15, to feed the sheet 9 toward the secondary transfer roller 15.

The image forming section 3 forms an image to be transferred onto the sheet 9 conveyed by the sheet feed and conveyance section 2. The image forming section 3 includes an intermediate transfer belt 24 stretched around a drive roller 20 and driven rollers 21 and 22. The intermediate transfer belt 24 is formed of an endless belt, and is circularly moved in a clockwise direction by the rotation of the drive roller 20. The image forming section 3 includes, below the intermediate transfer belt 24, imaging units 30K, 30Y, 30M, and 30C to form images in colors such as black (K), yellow (Y), magenta (M), and cyan (C).

The imaging units 30K, 30Y, 30M, and 30C generate toner images in the respective colors based on image data to be printed, and primarily transfer the toner images onto the intermediate transfer belt 24. Each of the imaging units 30K, 30Y, 30M, and 30C includes a photosensitive drum 31, a charging device 32, an exposure device 33, a developing device 34, a primary transfer roller 35, and a cleaner 36. The charging device 32, the exposure device 33, the developing device 34, the primary transfer roller 35, and the cleaner 36 are arranged around the photosensitive drum 31.

The charging device 32 uniformly charges the surface of the photosensitive drum 31 to a predetermined charge. The exposure device 33 is controlled by an exposure controller 28. The exposure device 33 forms an electrostatic latent image on the surface of the photosensitive drum 31 by exposing the surface of the photosensitive drum 31 according to image data of each color. The developing device 34 applies a developer containing toner to the surface of the photosensitive drum 31 and develops the electrostatic latent image with the toner. Thus, a toner image is formed on the surface of the photosensitive drum 31. The primary transfer roller 35 brings the intermediate transfer belt 24 into contact with the surface of the photosensitive drum 31, and primarily transfers the toner image on the photosensitive drum to the intermediate transfer belt 24 when a predetermined voltage is applied. The cleaner 36 discharges the surface of the photosensitive drum 31 after the primary transfer. and removes toner remaining on the surface of the photosensitive drum 31 from the photosensitive drum 31.

The imaging units 30K, 30Y, 30M, and 30C primarily transfer the toner images in the respective colors onto the same position on the intermediate transfer belt 24, which moves in a circular manner, so that the images are superimposed. As a result, a color image is formed on the surface of the intermediate transfer belt 24 after passing through the imaging unit 30C located at the most downstream position.

When the intermediate transfer belt 24 passes through the position of the secondary transfer roller 15, the image primarily transferred to the intermediate transfer belt 24 comes into contact with the surface of the sheet 9 conveyed by the sheet feed and conveyance section 2. At this time, a predetermined voltage is applied to the secondary transfer roller 15. Therefore, the image borne on the intermediate transfer belt 24 is secondarily transferred to the surface of the sheet 9 by the electrostatic force from the secondary transfer roller 15. As the result, the image is transferred onto the front surface of the sheet 9.

The toner remaining on the surface of the intermediate transfer belt 24 after the secondary transfer is removed from the surface of the intermediate transfer belt 24 by a cleaner 25 provided near the driven roller 21.

The sheet 9 onto which the image has been transferred by the secondary transfer roller 15 is conveyed along the conveyance path 13 and guided to the fixing device 4. The fixing device 4 fixes the image transferred onto the sheet 9 to the sheet 9. For example, the fixing device 4 includes a heating member 4a and a pressure member 4b. The heating member 4a and the pressure member 4b are in contact with each other to form a nip portion. When passing through the nip portion, the sheet 9 is subjected to a fixing process including a heating process and a pressing process. The image is fixed to the sheet 9 by the fixing processing. The sheet 9 on which the image has been fixed in the fixing device 4 is then ejected by sheet ejection rollers 16 to a sheet ejection tray 17 provided on a side surface of the apparatus main body 1a.

The image forming apparatus 1 includes a controller 27 that comprehensively controls the above-described operation. When a print job is executed in the image forming apparatus 1, the controller 27 controls driving of the sheet feed and conveyance section 2, the image forming section 3, and the fixing device 4 described above. In addition, when a print job is not executed, the controller 27 performs a process of shifting the image forming apparatus 1 to the power saving mode.

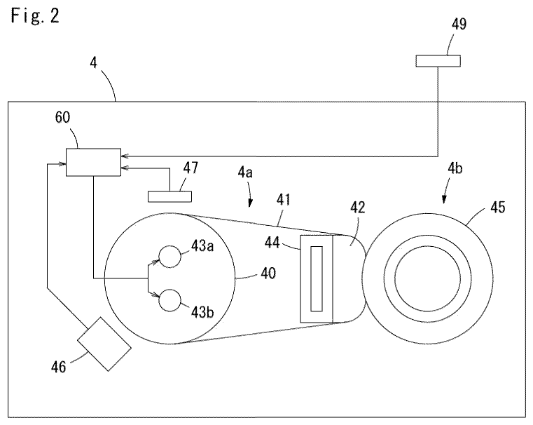

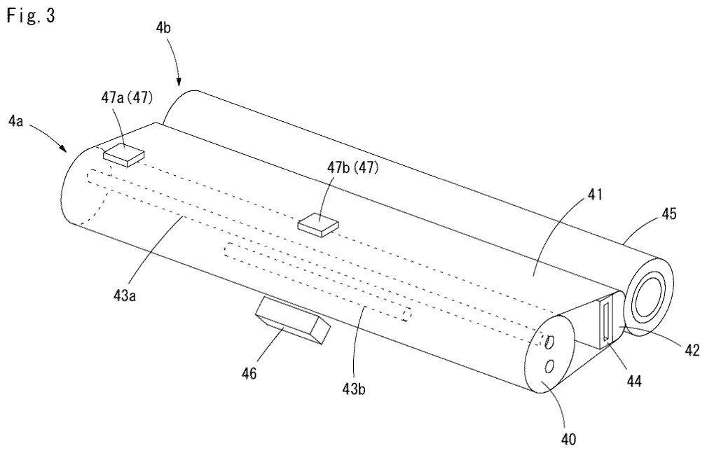

FIG. 2 is a diagram illustrating a detailed configuration of the fixing device 4. FIG. 3 is a perspective view illustrating the heating member 4a and the pressure member 4b of the fixing device 4. The heating member 4a includes a heating roller 40, a heating belt 41, a heating pad 42, heaters 43a and 43b. and a support member 44. The pressure member 4b includes a pressure roller 45.

The heaters 43a and 43b are heat sources that are disposed on an inner side of the heating roller 40 and heat the heating roller 40 from the inner side, and are configured by halogen lamps or the like, for example. As illustrated in FIG. 3, the heater 43a is a long heater provided inside the heating roller 40 over the entire area of the heating roller 40 in the axial direction. The heater 43b is a short heater provided inside the heating roller 40 and only at a center area of the heating roller 40 in the axial direction.

The heating belt 41 is an endless belt stretched between the heating roller 40 and the heating pad 42. The heating pad 42 is supported by a support member 44 at a position where the heating pad 42 can come into contact with the pressure roller 45. For example, the heating pad 42 is formed of an elastic member, such as rubber or a sponge, and a sliding sheet is adhered to a surface thereof. The heating belt 41 is stretched in a state of being in contact with the slide sheet, and thus is circularly moved by the rotation of the heating roller 40.

The pressure roller 45 is provided at a position facing the heating pad 42, and applies a predetermined pressing force to the heating belt 41 bridged over the heating pad 42.

The fixing device 4 includes a controller 60 that controls operations of the heating member 4a and the pressure member 4b. The controller 60 controls an operation of the fixing processing in the fixing device 4. For example, the controller 60 controls the rotation of the heating roller 40 and the pressure roller 45. In addition, the controller 60 performs on/off control of the heaters 43a and 43b which are heat sources. When the entire area of the heating roller 40 in the axial direction is heated, the controller 60 turns on the heater 43a. In contrast, when only the center area of the heating roller 40 in the axial direction is heated, the controller 60 turns on the heater 43b.

The fixing device 4 includes a temperature detection sensor 46 and a temperature measurement sensor 47. The temperature detection sensor 46 detects a surface temperature of the heating belt 41 at a position obliquely below the heating roller 40. The temperature detection sensor 46 is provided at a central position in an axial direction of the heating roller 40. The temperature measurement sensor 47 is provided as an internal temperature measurement sensor and measures the internal temperature of the fixing device 4. As shown in FIG. 3, the temperature measurement sensor 47 includes two temperature sensors 47a and 47b disposed above the heating roller 40. The temperature sensor 47a is provided above an end portion of the heating roller 40, and measures a temperature above the end portion of the heating roller 40. The temperature sensor 47b is provided above the center of the heating roller 40, and measures a temperature of an upper portion of the center of the heating roller 40.

The controller 60 performs control based on the surface temperature of the heating belt 41 detected by the temperature detection sensor 46 so that the surface temperature of the heating belt 41 becomes a pre determined temperature. For example, when a print job is executed in the image forming apparatus 1, the controller 60 performs control based on the temperature detected by the temperature detection sensor 46 so that the surface temperature of the heating belt 41 becomes the target temperature of the fixing process. For example, the target temperature of the fixing processing is 155° C. Further, when the fixing device 4 is held in the warm-up state in a state where a print job is not executed in the image forming apparatus 1, the controller 60 performs control such that the surface temperature of the heating belt 41 becomes the target temperature of the foam-up state. Also, when the fixing device 4 is held in the warm-up state, the controller 60 detects the surface temperature of the heating belt 41 based on the temperature detected by the temperature detection sensor 46. The target temperature in the warm-up state may be the same temperature as the target temperature when the fixing processing is performed, or may be lower than the target temperature when the fixing processing is performed. For example, the target temperature in the warm-up state is preset as a temperature within a range of 135 to 155° C.

Further, the controller 60 can adjust the temperature balance between the central portion and the end portions in the axial direction of the heating roller 40 during the execution of the print job. For example, when an image is formed on a sheet 9 having a specific size, it is assumed that the sheet 9 passes through substantially the entire region of the heating roller 40 in the axial direction. In this case, the sheet 9 of the specific size passes through the entire region of the nip portion formed by the heating member 4a and the pressure member 4b. Therefore, a temperature difference is unlikely to occur in the longitudinal direction of the heating roller 40 when an image is formed on the sheet 9 of the specific size. In this case, the controller 60 controls turning on and off of the heater 43a. thereby maintaining the entire heating belt 41 at a constant temperature.

On the other hand, when an image is formed on the sheet 9 having a size smaller than the specific size, the sheet 9 passes through only the central portion of the nip portion formed by the heating member 4a and the pressure member 4b, and does not pass through the end portion region of the nip portion. In this case, the heat of the central portion of the heating belt 41 is taken by the sheet 9, whereas the heat of the end portion region of the heating belt 41 is not taken by the sheet 9. Therefore, a temperature difference occurs in the longitudinal direction of the heating roller 40, and the temperature of the end portions becomes higher than the temperature of the center. Such a temperature difference is detected by the temperature sensors 47a and 47b. Therefore, when the temperature difference is detected by the temperature sensors 47a and 47b. the controller 60 controls turning on and off of the heater 43b to heat only the central portion of the heating roller 40, thereby eliminating the temperature difference in the longitudinal direction of the heating roller 40.

Further, the controller 60 is connected to a temperature measurement sensor 49 provided outside the fixing device 4 and inside of the apparatus main body la of the image forming apparatus 1. The temperature measurement sensor 49 is an external temperature measurement sensor that measures the external temperature of the fixing device 4. The controller 60 can detect the external temperature of the fixing device 4 by acquiring the temperature measured by the temperature measurement sensor 49.

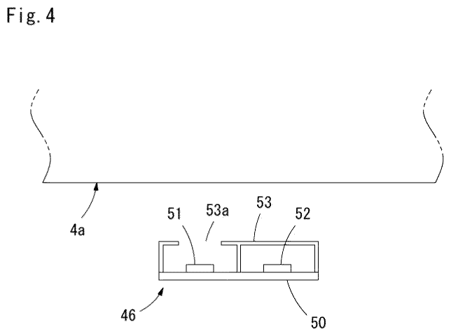

FIG. 4 is a diagram showing a configuration example of the temperature detection sensor 46. The temperature detection sensor 46 includes a substrate 50, a measurement detection element 51, a compensation detection element 52, and a casing 53. The measurement detection element 51 is an element that detects surface temperature of the heating member 4a, and is formed with, for example, a thermistor. The compensation detection element 52 is an element that detects an environmental temperature in an installation environment of the measurement detection element 51, and is formed of, for example, a thermistor. The measurement detection element 51 and the compensation detection element 52 are mounted on one substrate 50. The casing 53 is arranged so as to cover the surface of the substrate 50 on which the measurement detection element 51 and the compensation detection element 52 are mounted.

The casing 53 has an opening 53a at a position corresponding to the detection surface of the measurement detection element 51. The casing 53 guides the radiation heat from the heating member 4a to the detection surface of the measurement detection element 51 via the opening 53a. Therefore, the measurement detection element 51 detect the temperature of the heating member 4a based on the radiation heat from the heating member 4a. On the other hand, the casing 53 does not have an opening at a position corresponding to the detection surface of the compensation detection element 52, and covers the compensation detection element 52. Therefore, the casing 53 blocks the radiation heat from the heating member 4a without guiding the radiation heat to the compensation detection element 52. Therefore, the compensation detection element 52 detects the environment temperature of the environment in which the measurement detection element 51 is provided.

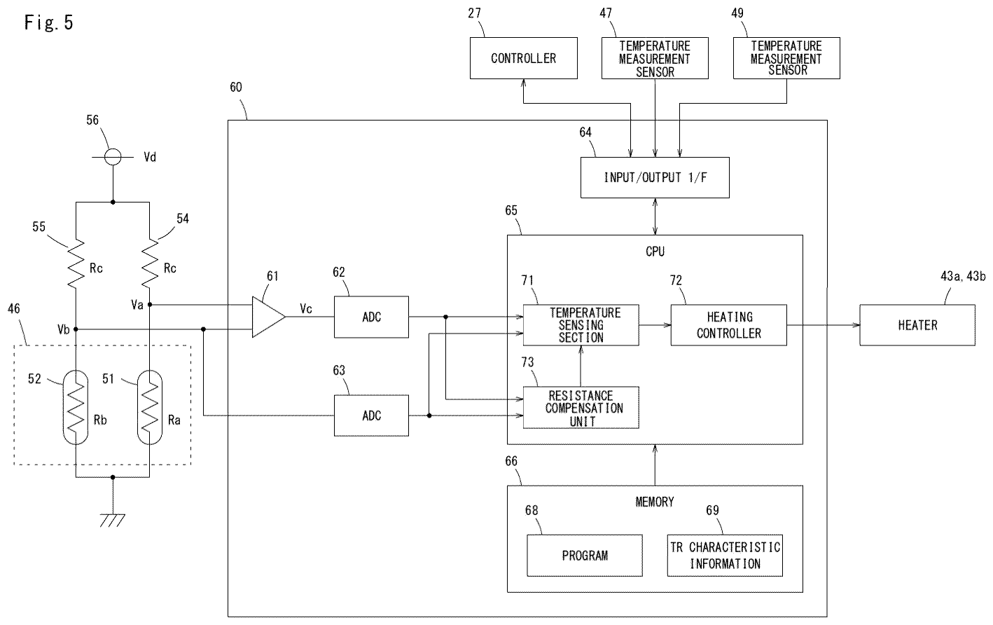

The controller 60 controls the temperature of the heating member ta based on the temperature detected by the temperature detection sensor 46 as described above. FIG. 5 is a block diagram illustrating the functional configuration of the controller 60. The measurement detection element 51 and the compensation detection element 52 of the temperature detection sensor 46 each include a resistor whose resistance value changes with temperature. The controller 60 detects the change in the resistance value and measures the temperature of the heating member 4a.

As illustrated in FIG. 5, the resistance value of the measurement detection element 51 is Ra, and the resistance value of the compensation detection element 52 is Rb. Provided that the measurement detection element 51 and the compensation detection element 52 are formed of the same element. One ends of the measurement detection element 51 and the compensation detection element 52 are connected to pull-up resistors 54 and 55, respectively, and are connected to a power source voltage 56 via the pull-up resistors 54 and 55. The output voltage of the power source voltage 56 is Vd. The resistance value of the pull-up resistors 54 and 55 is Rc. The other ends of the measurement detection element 51 and the compensation detection element 52 are connected to the ground.

The resistance value Ra of the measurement detection element 51 changes according to the surface temperature of the heating member 4a. Therefore, a voltage Va at a node between the measurement detection element 51 and the pull-up resistor 54 becomes a voltage corresponding to the surface temperature of the heating member 4a. The measurement detection element 51 outputs the voltage Va as an output voltage.

The resistance value Rb of the compensation detection element 52 changes according to the environmental temperature of the environment in which the temperature detection sensor 46 is provided. Therefore, the voltage Vb at a node between the compensation detection element 52 and the pull-up resistor 55 becomes a voltage corresponding to the environmental temperature of the temperature detection sensor 46. The compensation detection element 52 outputs the voltage Vb as an output voltage. The controller 60 calculates the resistance value of the temperature detection sensor 46 based on the output voltages Va and Vb, and detects the surface temperature of the heating member 4a. The controller 60 then controls heating of the heaters 43a and 43b serving as heat sources based on the surface temperature of the heating member 4a.

The controller 60 includes a differential amplifier 61, AD converters 62 and 63, an input/output interface 64, a CPU 65, and a memory 66. The CPU 65 is a hardware processor that reads and executes the program 68 stored in the memory 66. The memory 66 is a nonvolatile storage device constituted by a ROM or the like. A program 68 to be executed by the CPU 65 is stored in the memory 66 in advance. In addition, the memory 66 stores TR characteristic information 69 related to the measurement detection element 51 and the compensation detection element 52. The TR characteristic information 69 is information that defines the relationship between the temperature and the resistance value of the measurement detection element 51 and the compensation detection element 52. The input/output interface 64 connects each of the controller 27, the temperature measurement sensor 47, and the temperature measurement sensor 49 to the CPU 65.

The differential amplifier 61 outputs a differential voltage Vc between the output voltage Va of the measurement detection element 51 and the output voltage Vb of the compensation detection element 52. For example, the differential voltage Vc is Vc=Vb−Va.

The AD convertor 62 converts the differential voltage Ve outputted from the differential amplifier 61 into a digital signal of a predetermined number of bits, and outputs the digital signal to the CPU 65. The AD converter 63 converts the voltage Vb outputted by the compensation detection element 52 into a digital signal having a predetermined number of bits, and outputs the digital signal to the CPU 65.

The CPU 65 functions as a temperature sensing section 71, a heating controller 72, and a resistance compensation unit 73 by executing the program 68.

The temperature sensing section 71 detects the surface temperature of the heating member 4a based on the differential voltage Vc and the output voltage Vb outputted from the AD converters 62 and 63. For example, the temperature sensing section 71 calculates the output voltage Va of the measurement detection element 51 based on the differential voltage Vc and the output voltage Vb, and obtains the resistance value Ra of the measurement detection element 51. For example, the resistance value Ra is obtained by calculation of Ra=Rc·Va/(Vd−Va). Upon obtaining the resistance value Ra, the temperature sensing section 71 reads the TR characteristic information 69 from the memory 66 and detects the temperature of the heating member 4a based on the TR characteristic information 69.

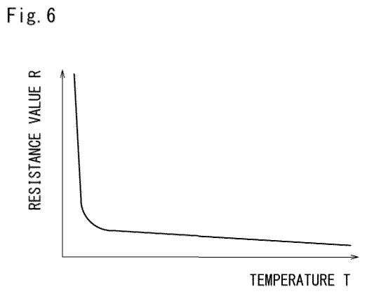

FIG. 6 is a view illustrating an example of the TR characteristic information 69. As shown in FIG. 6, the resistance value Ra of the measurement detection element 51 decreases as the temperature of the measurement target increases. Note that the TR characteristic of the compensation detection element 52 is similar to this. The temperature sensing section 71 detects the temperature of the heating member 4a corresponding to the resistance value Ra with reference to the TR characteristic information 69 as illustrated in FIG. 6.

The heating controller 72 controls, based on the temperature of the heating member 4a detected by the temperature sensing section 71, the heaters 43a and 43b so that the surface temperature of the heating member 4a becomes a predetermined target temperature. For example, the heating controller 72 communicates with the controller 27 to constantly monitor the operating state of the image forming apparatus 1. When a print job is executed in the image forming apparatus 1, the heating controller 72 performs control so that the temperature of the heating member 4a becomes the target temperature of the fixing process. Further, when the image forming apparatus 1 is in the warm-up state, the heating controller 72 performs control so that the temperature of the heating member 4a becomes the target temperature in the foam-up state. Further, when the image forming apparatus 1 shifts to the power saving mode, the controller 60 turns off the heaters 43a and 43b to reduce power consumption in the power saving mode.

The resistance values Ra and Rb of the measurement detection element 51 and the compensation detection element 52 change over time. When the resistance values Ra and Rb change with time, the temperature sensing section 71 cannot correctly detect the temperature of the heating member 4a. In order to prevent this, the CPU 65 causes the resistance compensation unit 73 to function.

The resistance compensation unit 73 compensates for changes over time in the resistance values Ra and Rb of the measurement detection element 51 and the compensation detection element 52. For example, when a deviation occurs between the resistance value Ra of the measurement detection element 51 and the resistance value Rb of the compensation detection element 52 due to a temporal change, the resistance compensation unit 73 performs a process of compensating for the deviation.

When the heating control of the heaters 43a and 43b is performed, the temperatures detected by the measurement detection element 51 and the compensation detection element 52 are different. Therefore, even if the compensation processing is performed in a state where the heating control of the heaters 43a and 43b is performed, the difference between the resistance values Ra and Rb cannot be eliminated. Further, even when the heating control of the heaters 43a and 43b is not performed, if the heating member 4a is not sufficiently cooled. the deviation between the resistance values Ra and Rb cannot be eliminated even if the compensation process is performed.

Therefore, the resistance compensation unit 73 performs compensation processing when a predetermined compensation condition is satisfied. The compensation condition for performing the compensation processing is that the heating member 4a has been sufficiently cooled and the measurement detection element 51 and the compensation detection element 52 are in the same temperature environment. However, it is not possible to directly detect whether the heating member 4a is in a sufficiently cooled state. Therefore, for example, when any one of the following first to sixth conditions is satisfied, the resistance compensation unit 73 determines that the compensation condition is satisfied.

The first condition is a timing immediately after the image forming apparatus 1 is powered on. Immediately after the image forming apparatus 1 is powered on, there is a high possibility that the heating member 4a is cooled to the same degree as the surrounding environment. Therefore, when the first condition is satisfied, the resistance compensation unit 73 determines that the compensation condition is satisfied and performs the compensation processing.

The second condition is a timing before the warm-up of the fixing device 4 is started. Before the warm-up of the fixing device 4 is started, there is a possibility that the heating member 4a is completely cooled. Therefore. when the second condition is satisfied, the resistance compensation unit 73 determines that the compensation condition is satisfied, and performs the compensation processing.

The third condition is that a predetermined time or more has elapsed from the end of the heating control of the heaters 43a and 43b by the controller 60. After the heating control of the heaters 43a and 43b ends. If the predetermined time or more has elapsed, there is a possibility that the heating member 4a has cooled down. Therefore, when the third condition is established, the resistance compensation unit 73 determines that the compensation condition is satisfied, and executes the compensation processing.

The fourth condition is that the internal temperature of the fixing device 4 detected by the temperature measurement sensor 47 is equal to or lower than a predetermined value. The temperature measurement sensor 47 measures the internal temperature of the fixing device 4 at a position above the heating member 4a. If the temperature at the upper position of the heating member 4a is the predetermined value or less, there is a high possibility that the heating member 4a is completely cooled. Therefore, when the fourth condition is established. the resistance compensation unit 73 determines that the compensation condition is satisfied, and executes the compensation processing.

The fifth condition is that the temperature difference between the internal temperature of the fixing device 4 detected by the temperature measurement sensor 47 and the external temperature of the fixing device 4 detected by the temperature measurement sensor 49 is equal to or less than a predetermined value. If the temperature difference between the inside and the outside of the fixing device 4 is equal to or smaller than the predetermined value, it is highly probable that the heating member 4a is completely cooled. Therefore, when the fifth condition is satisfied, the resistance compensation unit 73 determines that the compensation condition is satisfied, and executes the compensation processing.

The sixth condition is that the resistance compensation unit 73 estimates the internal temperature of the heating member 4a and the estimated internal temperature is equal to or lower than a predetermined value. For example, the resistance compensation unit 73 estimates the internal temperature of the heating member 4a on the basis of a control time during which the previous heating control for the heaters 43a and 43b is performed by the heating controller 72 and an elapsed time from the end of the previous heating control. When it is estimated that the internal temperature of the heating member 4a is equal to or lower than the predetermined value, there is a high possibility that the heating member 4a has cooled down. Therefore, when the estimated internal temperature of the heating member 4a is equal to or lower than a predetermined value, the resistance compensation unit 73 determines that the compensation condition is satisfied, and executes the compensation processing.

The resistance compensation unit 73 may determine that the compensation condition is satisfied when a plurality of conditions selected from the above-described first to sixth conditions are simultaneously satisfied.

Furthermore, even if the resistance compensation unit 73 determines that the compensation condition is satisfied, the resistance compensation unit 73 may not perform the compensation processing if a predetermined period of time has not elapsed since the last compensation processing was performed. As the predetermined period. for example, a period of one week or one month is set in advance. By setting such a predetermined period, it is possible to prevent the compensation processing by the resistance compensation unit 73 from being frequently executed.

When determining that the compensation condition is satisfied, the resistance compensation unit 73 executes compensation processing and calculates a correction coefficient for correcting the resistance value of the temperature detection sensor 46. That is, the resistance compensation unit 73 calculates the correction coefficient for correcting the resistance value in a state where the heating member 4a is sufficiently cooled down.

In a case where the resistance values Ra and Rb of the measurement detection element 51 and the compensation detection element 52 do not change with time, the resistance values Ra and Rb are equal to each other in a state where the heating member 4a is sufficiently cooled. However, in a case where the resistance values Ra and Rb of the measurement detection element 51 and the compensation detection element 52 have changed over time, a difference occurs between the resistance values Ra and Rb in a state where the heating member 4a is sufficiently cooled. The resistance compensation unit 73 calculates a correction coefficient for correcting the difference between the resistance values Ra and Rb in the compensation process. Hereinafter, details of the compensation processing will be specifically described.

When the compensation condition is satisfied, the resistance compensation unit 73 determines whether or not the differential voltage Vc output from the AD converter 62 is larger than 0. When the differential voltage Vc is 0, it means that the resistance values Ra and Rb are equal. On the other hand, when the differential voltage Vc is larger than 0, it means that there is a difference between the resistance values Ra and Rb. Therefore, the resistance compensation unit 73 determines, based on the differential voltage Vc outputted from the differential amplifier 61, whether or not it is necessary to calculate the correction coefficient.

When it is necessary to calculate the correction coefficient, the resistance compensation unit 73 calculates the output voltage Va of the measurement detection element 51 based on the differential voltage Vc and the output voltage Vb output from the AD converters 62 and 63, and obtains the resistance value Ra of the measurement detection element 51. For example, the resistance value Ra is obtained by calculation of Ra=Rc·Va/(Vd−Va). Further, the resistance compensation unit 73 obtains the resistance value Rb of the compensation detection element 52 based on the output voltage Vb output from the AD converter 63. For example, the resistance value Rb is obtained by calculation of R=Rc·Vb/(Vd−Vb).

After calculating the resistance values Ra and Rb, the resistance compensation unit 73 calculates a correction coefficient K based on the resistance values Ra and Rb. For example, the resistance compensation unit 73 calculates a ratio between the resistance value Ra and the resistance value Rb as the correction coefficient K. For example, the correction coefficient K is K=Rb/Ra. When the compensation process is not performed, the value of “1” is held as the initial value of the correction coefficient K. After calculating the correction coefficient K through the compensation processing, the resistance compensation unit 73 updates the correction coefficient K to the calculated value.

The resistance compensation unit 73 may limit the range of the correction coefficient K to a predetermined range. For example, when the calculated correction coefficient K is less than 1, the resistance compensation unit 73 sets the correction coefficient K to 1. Further, for example, when the calculated correction coefficient K exceeds a predetermined upper limit value (for example, 1.08), the resistance compensation unit 73 sets the correction coefficient K to the upper limit value (for example, 1.08). In this way, the resistance compensation unit 73 can suppress excessive correction by limiting the range of the correction coefficient K.

The updated correction coefficient K is used when the temperature sensing section 71 detects the temperature of the heating member 4a thereafter. That is, the temperature sensing section 71 calculates the output voltage Va of the measurement detection element 51 to obtain the resistance value Ra of the measurement detection element 51, and then corrects the resistance value Ra with the correction coefficient K. For example.

the temperature sensing section 71 corrects the resistance value Ra by multiplying the calculated resistance value Ra by the correction coefficient K. Next, the temperature sensing section 71 detects the temperature of the heating member 4a using the corrected resistance value Ra. Thus, the temperature sensing section 71 can accurately detect the temperature of the heating member 4a.

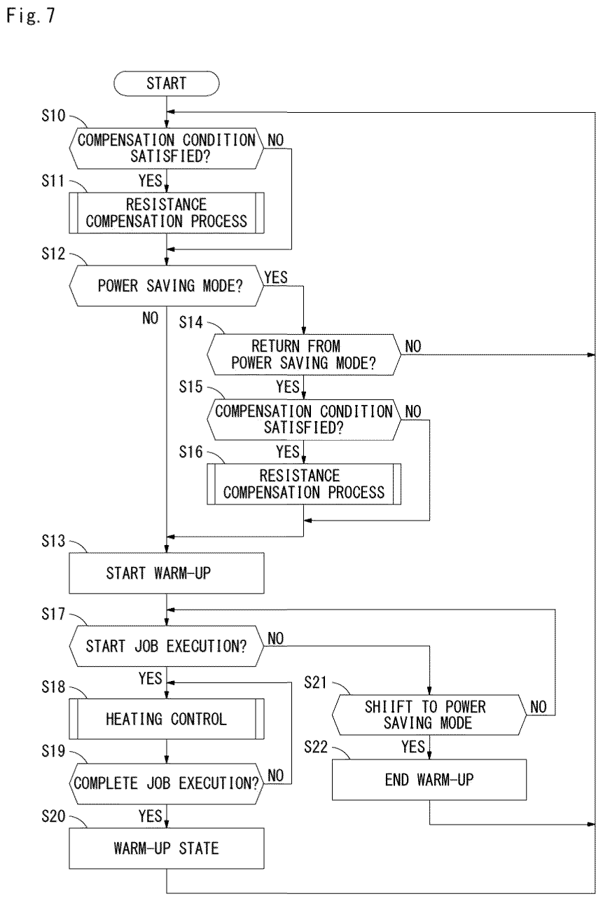

Next, an example of a processing procedure by the CPU 65 of the controller 60 will be described. FIGS. 7 to 9 are flowcharts showing an example of a processing procedure by the CPU 65 of the controller 60. This process is executed by the CPU 65 when the image forming apparatus 1 is powered on.

When starting the processing based on the flowchart, the CPU 65 causes the resistance compensation unit 73 to function and determines whether or not the above-described compensation condition is satisfied (step S10). That is, the resistance compensation unit 73 determines whether or not the compensation condition is satisfied by determining whether or not the first to sixth conditions described above are satisfied. When the compensation condition is satisfied (YES in step S10), the resistance compensation unit 73 performs the resistance compensation process (step S11). Details of the resistance compensation processing will be described later. When the compensation condition is not satisfied (NO in step S10), the resistance compensation unit 73 does not execute the resistance compensation process.

Next, CPU 65 determines whether or not the image forming apparatus 1 is in the power saving mode (step S12). If the image forming apparatus 1 is not in the power-saving mode (NO in step S12), the CPU 65 activates the temperature sensing section 71 and the heating controller 72 to start warm-up the fixing device 4 (step S13). For example, immediately after the image forming apparatus 1 is turned on, the image forming apparatus 1 is not in the power saving mode. Therefore, the CPU 65 determines that it is not in the power saving mode, and starts warm-up.

If the image forming apparatus 1 is in the power saving mode (YES in step S12), the CPU 65 determines whether or not it is time to return from the power saving mode (step S14). The timing at which the image forming apparatus 1 returns from the power saving mode includes, for example, a timing at which the image forming apparatus 1 receives a print job via a network. If it is not the timing to return from the power saving mode (NO in step S14), the process by the CPU 65 returns to step S10.

If it is the timing to return from the power saving mode (YES in step S14), the CPU 65 causes the resistance compensation unit 73 to function. Then, the resistance compensation unit 73 determines whether or not the above-described compensation condition is satisfied (step S15). That is, the resistance compensation unit 73 determines whether or not the compensation condition is satisfied by determining whether or not the first to sixth conditions described above are satisfied. When the compensation condition is satisfied (YES in step S15), the resistance compensation unit 73 performs the resistance compensation process (step S16). Details of the resistance compensation processing will be described later. When the compensation condition is not satisfied (NO in step S15), the resistance compensation unit 73 does not execute the resistance compensation process. Then, the CPU 65 activates the temperature sensing section 71 and the heating controller 72 to start warm-up the fixing device 4 (step S13).

After the CPU 65 starts warm-up of the fixing device 4, the controller 27 determines whether or not the execution of the print job is started (step S17). In a case where the execution of the print job is started by the controller 27 (YES in step S17), the CPU 65 executes the heating control of the heaters 43a and 43b (step S18).

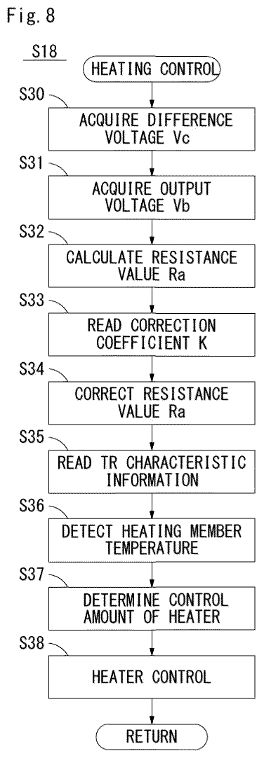

FIG. 8 is a flowchart illustrating an example of a detailed processing procedure of heating control (step S18). When the heating control is started, the CPU 65 first causes the temperature sensing section 71 to function. First, the temperature sensing section 71 acquires the differential voltage Vc (step S30). Subsequently, the temperature sensing section 71 acquires the output voltage Vb (step S31). Next, the temperature sensing section 71 calculates the resistance Ra of the measurement detection element 51 on the basis of the difference voltage Vc and the output voltage Vb (step S32).

After calculating the resistance value Ra, the temperature sensing section 71 reads the current correction coefficient K (step S33). Next, the temperature sensing section 71 corrects the calculated resistance value Ra with the correction coefficient K (step S34). When the correction coefficient K is 1, the resistance value Ra is not corrected in step S34.

Next, the temperature sensing section 71 reads the TR characteristic information 69 from the memory 66 (step S35). Next, the temperature sensing section 71 identifies the temperature corresponding to the resistance value Ra of the measurement detection element 51, and senses the identified temperature as the temperature of the heating member 4a (step S36).

Next, the CPU 65 causes the heating controller 72 to function. The heating controller 72 determines control amounts of the heaters 43a and 43b based on the temperature of the heating member 4a detected by the temperature sensing section 71. The control amount is, for example, a duty ratio for on-off control of the heaters 43a and 43b. The heating controller 72 controls the heaters 43a and 43b based on the control amounts (step S38).

Return to the flowchart of FIG. 7. The temperature sensing section 71 and the heating controller 72 repeatedly execute the processing of the heating control (step S18) as described above until the execution of the print job is finished (step S19). Next, when the execution of the print job is completed (YES in step S19), the temperature sensing section 71 and the heating controller 72 cause the fixing device 4 to transition to the warm-up state (step S20). Thereafter, the processing by CPU 65 returns to step S10.

On the other hand, when the execution of the print job is not started (NO in step S17), the CPU 65 determines, by the controller 27, whether to shift to the power saving mode (step S21). For example, when a predetermined time elapses in a state where a print job is not executed, the controller 27 starts processing for switching to the power saving mode. The CPU 65 determines whether or not a process for shifting to the power saving mode is performed by the controller 27. If the image forming apparatus 1 is not shifted to the power saving mode (NO in step S21), the process by the CPU 65 returns to step S17, and the image forming apparatus 1 waits for the execution of the print job.

When the controller 27 performs the process of shifting to the power saving mode (YES in step S21), the CPU 65 ends the warm-up of the fixing device 4 (step S22). Thus, the heating processing of the heating member 4a is not performed. Therefore, after the end of warm-up, the temperature of the fixing device 4 gradually decreases. Thereafter, the processing by CPU 65 returns to step S10, and repeats the above-described processing.

In the processing as described above, the CPU 65 determines every time whether or not a predetermined compensation condition is established (steps S10 and S15). As a result, when the predetermined compensation condition is satisfied (YES in step S10 or S15), the CPU 65 executes the resistance compensation process (steps S11 and S16). For example, the CPU 65 performs the resistance compensation processing (S11 and S16), when the heating member 4a is sufficiently cooled down.

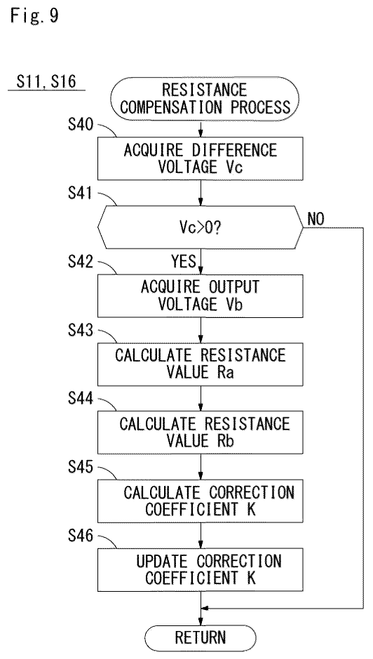

FIG. 9 is a flowchart illustrating an example of a detailed processing procedure of resistance compensation processing (steps S11 and S16). When starting the resistance compensation processing, the CPU 65 causes the resistance compensation unit 73 to function. The resistance compensation unit 73 acquires the differential voltage Vc (step S40). The resistance compensation unit 73 determines whether or not the acquired differential voltage Vc is greater than 0) (step S41). In a case where the differential voltage Vc is not 0 in a state where the heating member 4a is sufficiently cooled down, a difference occurs between the resistance value Ra and the resistance value Rb due to a temporal change. When the differential voltage Vc is zero, it means that the resistance values Ra and Rb have not changed with time.

When the differential voltage Vc is not larger than 0) (NO in step S41), the resistance compensation unit 73 determines that it is not necessary to compensate the resistance value. In this case, the resistance compensation processing ends.

If the differential voltage Vc is greater than 0) (YES in step S41), the resistance compensation unit 73 acquires the output voltage Vb (step S42). Then, the resistance compensation unit 73 calculates the resistance value Ra of the measurement detection element 51 based on the differential voltage Vc and the output voltage Vb (step S43). The resistance compensation unit 73 calculates the resistance value Rb of the compensation detection element 52 on the basis of the output voltage Vb (step S44).

After calculating the resistance values Ra and Rb, the resistance compensation unit 73 calculates the correction coefficient K (step S45). Then, the resistance compensation unit 73 updates the correction coefficient K (step S46). When the correction coefficient K is read in the subsequent heating control (step S18), the correction coefficient K updated in step S46 is read.

As described above, the fixing device 4 according to the present embodiment includes the heating controller 72 that calculates the resistance value of the temperature detection sensor 46 based on the voltage outputted from the temperature detection sensor 46 to detect the temperature of the heating member 4a. and controls heating of the heaters 43a and 43b as heat sources. When a predetermined compensation condition is satisfied, the fixing device 4 executes resistance compensation processing for correcting the resistance value of the temperature detection sensor 46 on the basis of the output voltage of the temperature detection sensor 46 and calculates a correction coefficient K. When detecting the temperature of the heating member 4a, the heating controller 72 corrects the resistance value of the temperature detection sensor 46 by using the correction coefficient K calculated by the resistance compensation processing. According to such a fixing device 4, even when the resistance value of the temperature detection sensor 46 changes due to a temporal change, the resistance value of the temperature detection sensor 46 can be corrected using the correction coefficient K calculated by the resistance compensation process. Therefore, even in a case where the resistance value of the temperature detection sensor 46 has changed over time, the fixing device 4 can perform heating control while detecting the correct temperature of the heating member 4a.

### MODIFICATION EXAMPLE

A preferred embodiment of the present invention has been described above. However, the present invention is not limited to the content described in the above embodiment, and various modification examples are applicable. For example, in the above-described embodiment, the case where the controller 60 that controls the heaters

43a and 43b serving as heat sources is provided in the fixing device 4 has been exemplified. However, the controller 60 described above is not limited to being provided in the fixing device 4. For example, the controller 60 may be provided outside the fixing device 4 and on the apparatus main body 1a of the image forming apparatus 1.

Furthermore, in the above-described embodiment, the configuration example in which the heating member 4a includes the heating roller 40 and the heating belt 41 has been described. However, the heating member 4a is not limited to such a configuration. For example, the heating member 4a may be configured to include only the heating roller 40. In that case, the heating roller 40 forms a nip portion with the pressure roller 45.

Although embodiments of the present invention have been described and illustrated in detail, the disclosed embodiments are made for purposes of illustration and example only and not limitation. The scope of the present invention should be interpreted by terms of the appended claims.

What is claimed is:

1. A fixing device comprising:
a heating member provided with a heat source:
a temperature detection sensor that changes a resistance value according to a temperature of the heating member; and
a controller that calculates the resistance value of the temperature detection sensor based on an output voltage of the temperature detection sensor to detect the temperature of the heating member, and controls heating of the heat source, wherein
the controller calculates a correction coefficient for correcting the resistance value of the temperature detection sensor on the basis of an output voltage of the temperature detection sensor when a predetermined compensation condition is satisfied, and corrects the resistance value of the temperature detection sensor using the correction coefficient when the temperature of the heating member is detected.

2. The fixing device according to claim 1, wherein
the temperature detection sensor includes a measurement detection element that detects a surface temperature of the heating member and a compensation detection element that detects an environmental temperature, and
the controller calculates the correction coefficient when there is a difference between an output voltage of the measurement detection element and an output voltage of the compensation detection element.

3. The fixing device according to claim 2, wherein
the controller calculates, when there is a difference between the output voltage of the measurement detection element and the output voltage of the compensation detection element, a first resistance value which is a resistance value of the measurement detection element from the output voltage of the measurement detection element, calculates a second resistance value which is a resistance value of the compensation detection element from the output voltage of the compensation detection element, and calculates a ratio between the first resistance value and the second resistance value as the correction coefficient.

4. The fixing device according to claim 2, wherein
the temperature detection sensor includes a casing that holds the measurement detection element and the compensation detection element, and
the casing is opened at a position corresponding to the measurement detection element to guide radiant heat from the heating member to the measurement detection element, and covers a position corresponding to the compensation detection element to block the radiant heat from the heating member.

5. The fixing device according to claim 1, wherein
the controller calculates the correction coefficient when a predetermined time has elapsed from the end of heating control of the heat source.

6. The fixing device according to claim 1, wherein
the controller calculates the correction coefficient before starting warm-up of the heat source.

7. The fixing device according to claim 1, further comprising:
an internal temperature measuring sensor for measuring a temperature inside the fixing device, wherein the controller calculates the correction coefficient when the temperature measured by the internal temperature measurement sensor is equal to or lower than a predetermined value.

8. The fixing device according to claim 1, further comprising:
an internal temperature measuring sensor for measuring an internal temperature inside the fixing device: and
an external temperature measurement sensor for measuring an external temperature outside the fixing device, wherein
the controller calculates the correction coefficient when a temperature difference between the internal temperature and the external temperature is equal to or less than a predetermined value.

9. The fixing device according to claim 1, wherein
the controller estimates an internal temperature of the heating member, and calculates the correction coefficient when the internal temperature of the heating member is estimated to be equal to or lower than a predetermined temperature.

10. The fixing device according to claim 9, wherein
the controller estimates the internal temperature of the heating member on the basis of a control time during which a previous heating control is performed on the heat source and an elapsed time after the previous heating control ends.

11. An image forming apparatus comprising:
an image forming unit that forms an image on a sheet; and
a fixing device that fixes the image on the sheet; wherein
the fixing device includes a heating members provided with heat sources, a temperature detection sensor that changes a resistance value in accordance with a temperature of the heating member, and a controller that calculates the resistance value of the temperature detection sensor based on an output voltage of the temperature detection sensor to detect the temperature of the heating member, and controls heating of the heat source, and
the controller calculates a correction coefficient for correcting the resistance value of the temperature detection sensor on the basis of an output voltage of the temperature detection sensor when a predetermined compensation condition is satisfied, and corrects the resistance value of the temperature detection sensor using the correction coefficient when the temperature of the heating member is detected.

12. The image forming apparatus according to claim 11, wherein
the temperature detection sensor includes a measurement detection element that detects a surface temperature of the heating member and a compensation detection element that detects an environmental temperature, and
the controller calculates the correction coefficient when there is a difference between an output voltage of the measurement detection element and an output voltage of the compensation detection element.

13. The image forming apparatus according to claim 12, wherein
the controller calculates, when there is a difference between the output voltage of the measurement detection element and the output voltage of the compensation detection element, a first resistance value which is a resistance value of the measurement detection element from the output voltage of the measurement detection element, calculates a second resistance value which is a resistance value of the compensation detection element from the output voltage of the compensation detection element, and calculates a ratio between the first resistance value and the second resistance value as the correction coefficient.

14. The image forming apparatus according to claim 12, wherein
the temperature detection sensor includes a casing that holds the measurement detection element and the compensation detection element, and
the casing is opened at a position corresponding to the measurement detection element to guide radiant heat from the heating member to the measurement detection element, and covers a position corresponding to the compensation detection element to block the radiant heat from the heating member.

15. The image forming apparatus according to claim 11, wherein
the controller calculates the correction coefficient when a predetermined time has elapsed from the end of heating control of the heat source.

16. The image forming apparatus according to claim 11, wherein
the controller calculates the correction coefficient before starting warm-up of the heat source.

17. The image forming apparatus according to claim 11, further comprising:
an internal temperature measuring sensor for measuring a temperature inside the fixing device, wherein the controller calculates the correction coefficient when the temperature measured by the internal temperature measurement sensor is equal to or lower than a predetermined value.

18. The image forming apparatus according to claim 11, further comprising:
an internal temperature measuring sensor for measuring an internal temperature inside the fixing device: and
an external temperature measurement sensor for measuring an external temperature outside the fixing device, wherein
the controller calculates the correction coefficient when a temperature difference between the internal temperature and the external temperature is equal to or less than a predetermined value.

19. The image forming apparatus according to claim 11, wherein
the controller estimates an internal temperature of the heating member, and calculates the correction coefficient when the internal temperature of the heating member is estimated to be equal to or lower than a predetermined temperature.

20. A control method of a fixing device including a heating member provided with a heating source, and a temperature detection sensor that changes a resistance value in accordance with a temperature of the heating member, the control method comprising:
calculating the resistance value of the temperature detection sensor based on an output voltage of the temperature detection sensor to detect the temperature of the heating member,
controlling heating of the heat source based on the detected temperature of the heating member,
calculating a correction coefficient for correcting the resistance value of the temperature detection sensor on the basis of an output voltage of the temperature detection sensor when a predetermined compensation condition is satisfied; and
correcting the resistance value of the temperature detection sensor using the correction coefficient when the temperature of the heating member is detected.
